(19) United States
(12) Patent Application Publication
(10) Pub. No.: US 2014/0266578 A1
(43) Pub. Date: Sep. 18, 2014

(54) OPERATION CONTROL SYSTEM, INFORMATION PROCESSING APPARATUS, INFORMATION PROCESSING METHOD AND NON-TRANSITORY RECORDING MEDIUM RECORDED WITH PROGRAM

(71) Applicant: NK WORKS CO., LTD., Wakayama-shi (JP)

(72) Inventor: Toru Yasukawa, Wakayama-shi (JP)

(73) Assignee: NK WORKS CO., LTD., Wakayama-shi (JP)

(21) Appl. No.: 14/206,584

(22) Filed: Mar. 12, 2014

(30) Foreign Application Priority Data
Mar. 15, 2013 (JP) 2013-052602

(51) Int. Cl. G05B 9/02

(52) U.S. Cl. CPC G05B 9/02
USPC 340/5.6

(57) ABSTRACT

An operation control system according to one aspect of the invention is disclosed, which includes: a wireless communication apparatus carried by a user; a receiving apparatus receiving information transmitted from the wireless communication apparatus; and an information processing apparatus controlling a control target apparatus, specifying a communication status of the wireless communication apparatus by determining if the receiving apparatus receives the information from the wireless communication apparatus, and controlling an operation status of the control target apparatus based on specified communication status.

### FIELD

The present invention relates to an operation control system, an information processing apparatus, an information processing method and a non-transitory recording medium recorded with a program.

### BACKGROUND

There is a technology (Japanese Patent Application Laid-Open Publication No. 2007-315965) of distinctively presuming whether a human body stays within a detection area and remains static therein or the human body exits the detection area by use of a pyroelectric sensor, and, when presuming that the human body moves outside the detection area from inside the detection area, switching off a power source of a video display apparatus.

There is another technology (Japanese Patent Application Laid-Open Publication No. 2010-257313) of acquiring information necessary for authentication from an authentication apparatus for entering or exiting a room, managing a stay-in-room state in a management area on the basis of the information necessary for the authentication, and shifting, when an existence state of a user in the management area is shifted to a non-existence state thereof, the authentication apparatus for exiting the room from a normal status of supplying electric power to all devices to a sleep status of stopping the supply of the electric power to some number of devices exclusive of the device needed for restarting.

In recent years, multiple apparatuses have been employed in a variety of situations. Then, for various reasons, the user of the apparatus is required to manually operate an operation status of a target apparatus. For example, a hospital introduces a watching system for detecting behaviors of an inpatient such as a get-up state, a sitting-on-bed-edge state and a leaving-bed state by use of instruments, e.g., a load sensor, a body motion type wire, an infrared-ray sensor, etc. The user such a nurse and a care worker stops a function related to the watching system for the reason of conducting an operation within a patient's room or a care facility room and restarts the stopped function of the watching system after finishing the operation. Thus, in the case of manually operating the operation status of the apparatus, there exists a possibility of causing a human error such as failing to start up.

### SUMMARY

An operation control system according to one aspect of the present invention includes: a wireless communication apparatus to be carried by a user; a receiving apparatus to receive information transmitted from the wireless communication apparatus; and an information processing apparatus to control a control target apparatus, to specify a communication status of the wireless communication apparatus by determining whether or not the receiving apparatus receives the information transmitted from the wireless communication apparatus, and to control an operation status of the control target apparatus on the basis of the specified communication status.

Herein, the control target apparatus is an apparatus of which the operation status is controlled by the information processing apparatus, may be the information processing apparatus itself and may also be an apparatus other than the information processing apparatus.

Further, the information processing apparatus may, by way of controlling the operation status, control starting up and stopping a function executed on the control target apparatus and may also control a state of a power source of the control target apparatus. A control mode of the operation status may be properly set corresponding to the embodiment.

Further, a relationship between the communication status of the wireless communication apparatus and the operation status to be controlled may be properly set corresponding to an embodiment. For example, the information processing apparatus may stop a function executed by the control target apparatus during a period when the wireless communication apparatus is enabled to perform communications with the receiving apparatus, and may start up the function executed by the control target apparatus during a period when the wireless communication apparatus is disabled from performing the communications with the receiving apparatus.

According to the configuration described above, the communication status of the wireless communication apparatus is specified by determining whether or not the receiving apparatus receives the information transmitted from the wireless communication apparatus carried by the user. Then, the operation status of the control target apparatus is controlled corresponding to the communication status of the wireless communication apparatus.

Hence, according to the configuration described above, the operation status of the control target apparatus can be controlled corresponding to the communication status between the wireless communication apparatus carried by the user and the receiving apparatus, and in consequence it is feasible to easily control the operation status of the control target apparatus without being time-consuming in operation of the user. Then, the human error such as failing to start up can be prevented.

Moreover, in another mode of the operation control system according to one aspect, the information processing apparatus may, by way of controlling the operation status, control starting up and stopping a function executed on the information processing apparatus. According to the configuration described above, it is possible to control starting up and stopping the function executed on the information processing apparatus on the basis of the communication status of the wireless communication apparatus carried by the user.

Further, in still another mode of the operation control system according to one aspect, the information transmitted from the wireless communication apparatus may contain identifying information for identifying the user. Then, the information processing apparatus may specify the communication status of the wireless communication apparatus carried by a predetermined user in a way that refers to the identifying information contained in the received information when determining whether or not the receiving apparatus receives the information transmitted from the wireless communication apparatus, and may control the operation status of the control target apparatus on the basis of the specified communication status of the wireless communication apparatus carried by the predetermined user. According to the configuration described above, the operation status of the control target apparatus is controlled by identifying the user of the wireless communication apparatus, and hence it is feasible to restrict the user who controls the operation status of the control target apparatus.

Moreover, in yet another mode of the operation control system according to one aspect, the information transmitted from the wireless communication apparatus may contain identifying information for identifying the user. Then, the information processing apparatus may specify the communication status of the wireless communication apparatus carried by a predetermined user in a way that refers to the identifying information contained in the received information when determining whether or not the receiving apparatus receives the information transmitted from the wireless communication apparatus, and may determine whether or not an operation with respect to the information processing apparatus is accepted on the basis of the specified communication status of the wireless communication apparatus carried by the predetermined user. According to the configuration described above, it is determined whether or not the operation with respect to the information processing apparatus is accepted on the basis of the specified communication status of the wireless communication apparatus carried by the predetermined user, thereby enabling the restriction of the user who can operate the information processing apparatus.

Furthermore, in still yet another mode of the operation control system according to one aspect, the information transmitted from the wireless communication apparatus may contain identifying information for identifying the user. Then, the information processing apparatus may identify the user of the wireless communication apparatus in a way that refers to the identifying information contained in the received information when determining whether or not the receiving apparatus receives the information transmitted from the wireless communication apparatus, and may record a history related to the specified communication status of the wireless communication apparatus carried by the identified user. According to the configuration described above, it is possible to record the history of the communication status of the wireless communication apparatus on the user-by-user basis, the history serving as a criterion for making the determination as to the control of the operation status of the control target apparatus.

Herein, the communication status of the wireless communication apparatus indicates whether or not the receiving apparatus receives the information transmitted from the wireless communication apparatus. It is determined basically based on a distance between the wireless communication apparatus and the receiving apparatus whether or not the receiving apparatus can receive the information transmitted from the wireless communication apparatus. Namely, the user carrying the wireless communication apparatus exists in a communicable area between the wireless communication apparatus and the receiving apparatus when the receiving apparatus receives the information transmitted from the wireless communication apparatus. Whereas when the receiving apparatus does not receive the information transmitted from the wireless communication apparatus, it follows that the user does not exist in the communicable area between the wireless communication apparatus and the receiving apparatus.

Hence, according to the configuration described above, the history of the communication status of the wireless communication apparatus is recorded on the user-by-user basis. It is therefore feasible to record the history as to whether or not the user exists in the communicable area on the user-by-user basis together with the history of the operation control based on the communication status.

Moreover, Further, in yet another mode of the operation control system according to one aspect, a communicable area between the wireless communication apparatus and the receiving apparatus may be set to include an operation area in which the user conducts an operation. Then, the information processing apparatus may keep the operation status of the control target apparatus in a first operation status, corresponding to a situation that the wireless communication apparatus carried by the user is in a communication-enabled status with the receiving apparatus during a period when the user exists in the operation area, and may set the operation status of the control target apparatus in a second operation status, corresponding to a situation that the user exits the operation area, and the wireless communication apparatus carried by the user becomes a communication-disabled status with the receiving apparatus. According to the configuration described above, the operation status of the control target apparatus can be controlled based on the operation area of the user.

It is to be noted that another mode of the operation control system according to one aspect may be an information processing apparatus realizing the respective configurations described above, may also be an information processing method, may further be a program, and may yet further be a non-transitory storage medium recording a program, which can be read by a computer, other apparatuses and machines. Herein, the recording medium readable by the computer etc is a medium that accumulates the information such as the program electrically, magnetically, mechanically or by chemical action.

For example, an information processing apparatus according to one aspect of the present invention includes: a communication status specifying unit to specify a communication status of a wireless communication apparatus by determining whether or not a receiving apparatus receives information transmitted from the wireless communication apparatus carried by a user; and an operation control unit to control an operation status of an control target apparatus on the basis of the specified communication status of the wireless communication apparatus.

Further, an information processing method according to one aspect of the present invention is a method by which a computer executes: specifying a communication status of a wireless communication apparatus by determining whether or not a receiving apparatus receives information transmitted from the wireless communication apparatus carried by a user; and controlling an operation status of a control target apparatus on the basis of the specified communication status of the wireless communication apparatus.

Moreover, according to one aspect of the present invention, a non-transitory recording medium records a program to make a computer execute: specifying a communication status of a wireless communication apparatus by determining whether or not a receiving apparatus receives information transmitted from the wireless communication apparatus carried by a user; and controlling an operation status of a control target apparatus on the basis of the specified communication status of the wireless communication apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A is a view illustrating a situation of how an operation control system according to an embodiment is utilized; and FIG. 1B is a view illustrating the situation of how the operation control system according to the embodiment is utilized;

FIG. 2 is a diagram illustrating a hardware configuration of the operation control system according to the embodiment;

FIG. 3 is a diagram depicting a functional configuration of an information processing apparatus according to the embodiment;

FIG. 4 is a flowchart illustrating a processing procedure of the information processing apparatus according to the embodiment; and

FIG. 5 is a view illustrating another situation of how the operation control system according to the embodiment is utilized.

### DESCRIPTION OF EMBODIMENT

An embodiment (which will hereinafter be also termed “the present embodiment”) according to one aspect of the present invention will hereinafter be described based on the drawings. However, the present embodiment, which will hereinafter be explained, is no more than an exemplification of the present invention in every point. As a matter of course, the invention can be improved and modified in a variety of forms without deviating from the scope of the present invention. Namely, on the occasion of carrying out the present invention, a specific configuration corresponding to the embodiment may properly be adopted.

Note that data occurring in the present embodiment are, though described in a natural language, specified more concretely by use of a quasi-language, commands, parameters, a machine language, etc, which are recognizable to a computer.

### §1 Example of Applied Situation

FIGS. 1A and 1B each illustrate a situation to which the present invention is applied. In the present embodiment, a user carries a wireless communication apparatus 1. A receiving apparatus 2 receives information transmitted from the wireless communication apparatus 1 carried by the user. Then, the information processing apparatus 3 determines whether or not the receiving apparatus 2 can receive the information transmitted from the wireless communication apparatus 1, thereby specifying a communication status of the wireless communication apparatus 1. The information processing apparatus 3 controls an operation status of a control target apparatus on the basis of the thus specified communication status.

Note that the control target apparatus may be the information processing apparatus 3 and may also be an apparatus other than the information processing apparatus 3. The operation status of the control target apparatus is controlled. Further, a control mode of the operation status may be properly set corresponding to the embodiment. For example, the information processing apparatus 3 may, by way of controlling the operation status, control a start and a stop of a function executed in the control target apparatus, and may control a status of a power supply of the control target apparatus. In the present embodiment, the information processing apparatus 3 controls, by way of controlling the operation status, the start and the stop of the function executed in the information processing apparatus 3.

FIG. 1A depicts a situation in which the user enters an area (as defined by “Communicable Area” in FIG. 1A) in which the wireless communication apparatus 1 and the receiving apparatus 2 are communicable with each other, whereby the wireless communication apparatus 1 gets enabled to perform communications with the receiving apparatus 2. In this case, the information processing apparatus 3 according to the present embodiment stops the function of the control target apparatus on the basis of the communication status indicating that the wireless communication apparatus 1 can perform the communications with the receiving apparatus 2.

While on the other hand, FIG. 1B illustrates a situation in which the wireless communication apparatus 1 gets disabled from performing the communications with the receiving apparatus 2 when the user exits the communicable area. In this case, the information processing apparatus 3 according to the present embodiment starts up the function of the control target apparatus on the basis of the communication status indicating that the wireless communication apparatus 1 is disabled from performing the communications with the receiving apparatus 2.

Namely, in the present embodiment, the user enters the communicable area while carrying the wireless communication apparatus thereby enabling the control target function of the information processing apparatus 3 to be stopped. Further, the user exits the communicable area while carrying the wireless communication apparatus 1, thereby enabling the control target function to be started up.

Note that a relationship of how the communication status is associated with a content of the control is not limited to this example and may be properly set corresponding to the embodiment. For instance, the information processing apparatus 3 may start up the control target function on the basis of the communication status indicating that the wireless communication apparatus 1 gets enabled to perform the communications with the receiving apparatus 2. The information processing apparatus 3 may stop the control target function on the basis of the communication status indicating that the wireless communication apparatus 1 gets disabled from performing the communications with the receiving apparatus 2.

Moreover, the control target function is not particularly limited but may be properly selected from within functions equipped in the information processing apparatus 3. For example, if the information processing apparatus 3 has a function as the foregoing watching system utilized in a medical treatment facility or a care facility, the function related to the watching system may also be selected as the control target function. With this contrivance, the user such as a nurse and a care worker can start up and stop the function related to the watching system without being time-consuming in operation. Then, it is feasible to prevent a human error such as failing to start up the function.

Further, a range of the communicable area involved in controlling the operation status may be properly controlled. For example, an intensity of radio waves is weakened by sealing a metallic material to the wireless communication apparatus 1, and a communicable distance between the wireless communication apparatus 1 and the receiving apparatus 2 can be thus narrowed. Herein, the metallic material may be a material for narrowing the communicable distance of the wireless communication apparatus 1. An aluminum foil can be given by way of one example of the metallic material. In this case, the communicable distance between the wireless communication apparatus 1 and the receiving apparatus 2 can be controlled by adjusting a ratio at which the surface of the wireless communication apparatus 1 is covered with the aluminum foil.

The information processing apparatus 3 according to the present embodiment thus operates, whereby the operation status of the control target apparatus can be easily controlled without being time-consuming in operation of the user.

### §2 Example of Configuration

### Example of Hardware Configuration

FIG. 2 illustrates hardware configurations of the wireless communication apparatus 1, the receiving apparatus 2 and the information processing apparatus 3 that are included in an operation control system 9.

(Wireless Communication Apparatus)

The wireless communication apparatus 1 includes a voltage limit circuit 11, a rectifier circuit 12, a demodulator circuit 13, a modulator circuit 14, a control circuit 15, a memory circuit 16 and an antenna 17. As for the specific hardware configuration of the wireless communication apparatus 1, the components thereof can be properly omitted, replaced and added corresponding to the embodiment.

The voltage limit circuit 11 is a circuit for protecting internal circuits from an excessive input to the antenna 17. The rectifier circuit 12 converts an alternating current inputted to the antenna 17 into a direct current, and supplies power to the internal circuits. The demodulator circuit 13 demodulates an AC signal inputted to the antenna 17, and transmits the demodulated signal to the control circuit 15. On the other hand, the modulator circuit 14 modulates the signal coming from the control circuit 15, and transmits information to the receiving apparatus 2 via the antenna 17.

The control circuit 15 is a circuit for controlling an operation of the wireless communication apparatus 1, and executes a variety of arithmetic processes corresponding to the inputted signals. The control circuit 15 may be built up by a logical circuit to a minimum requirement for the purpose of restraining power consumption and may also be built up by a large-scale circuit such as a CPU (Central Processing Unit).

The memory circuit 16 is a circuit for recording the information. As will be described later on, the present embodiment assumes an RF (Radio Frequency) tag as the wireless communication apparatus 1. Therefore, a memory area of the memory circuit 16 may include an area for storing a unique ID of the tag and accepting only reading. Incidentally, the memory circuit 16 can involve using, e.g., an EPROM (Electrically Programmable Read Only Memory), an EEPROM (Electrically Erasable and Programmable Read Only Memory), an FeRAM (Ferro electric Random. Access Memory), an SRAM (Static Random Access Memory), etc.

It is to be noted that the information transmitted from the wireless communication apparatus 1 may contain identifying information for identifying a user carrying the wireless communication apparatus 1 in the present embodiment. In this case, the identifying information is written to the memory circuit 16, and the control circuit 15 transmits the identifying information to the receiving apparatus 2 by properly controlling the modulator circuit 14. Herein, the identifying information may have any type of contents if being the information from which the user can be identified. For example, a unique ID that is uniquely allocated to the wireless communication apparatus 1 may be used as the identifying information.

Moreover, the present embodiment assumes that a passive tag in RFID (Radio Frequency IDentification) tag is used as the wireless communication apparatus 1. The wireless communication apparatus 1 is available if being an apparatus capable of transmitting the information through the wireless communications, however, apparatuses other than the RF tag may also be employed. For instance, a wireless-communication enabled user terminal such as a mobile phone and a smartphone may also be utilized as the wireless communication apparatus 1. Furthermore, not the passive tag but an active tag (including power sources) may also be used as the wireless communication apparatus 1.

Moreover, the telecommunications standard of the wireless communication apparatus 1 may be properly determined corresponding to the embodiment. For example, Wi-Fi (registered trademark), Bluetooth (registered trademark), ZigBee (registered trademark), UWB (Ultra Wide Band), etc may be utilized as the telecommunications standard of the wireless communication apparatus 1. In the case of employing the operation control system 9 according to the present embodiment in medical treatment sites, however, it is preferable to utilize the telecommunications standards not affecting medical devices such as heart pacemakers.

Further, a mode of how the user carries the wireless communication apparatus 1 may be properly determined corresponding to the embodiment. In the present embodiment, as illustrated in FIGS. 1A and 1B, the wireless communication apparatus 1 (RF tag) is attached to a nameplate fitted to the vicinity of a breast of the user. Herein, it is assumed that the wireless communication apparatus 1 is basically carried by the user at all times. It is therefore preferable that the wireless communication apparatus 1 is reduced in size and weight to an extent that does not restrict activities of the user. Furthermore, the smaller size and the lighter weight can make the user easier to carry the wireless communication apparatus 1 and can make the user harder to be aware of carrying the wireless communication apparatus 1.

(Receiving Apparatus)

The receiving apparatus 2 includes an oscillating circuit 21, a control circuit 22, a modulator circuit 23, a transmitting circuit 24, a receiving circuit 25, a demodulator circuit 26 and an antenna 27. As for the specific hardware configuration of the receiving apparatus 2, the components thereof can be properly omitted, replaced and added corresponding to the embodiment.

The oscillating circuit 21 generates carrier waves used for the communications with the wireless communication apparatus 1. The control circuit 22 performs controlling from the side of the receiving apparatus 2 such as controlling the communications with the information processing apparatus 3 and controlling the communications with the wireless communication apparatus 1.

The modulator circuit 23 modulates the signals coming from the control circuit 22 by superimposing the signals onto the carrier waves generated in the oscillating circuit 21, and transmits the modulated signals to the transmitting circuit 24. Then, the transmitting circuit 24 transmits the signals superimposed onto the carrier waves sent from the modulator circuit 23 to the wireless communication tag 1 via the antenna 27. On the other hand, the receiving circuit 25 receives the carrier waves transmitted from the wireless communication apparatus 1 and entering via the antenna 27. Then, the demodulator circuit 26 demodulates the signals superimposed onto the carrier waves received by the receiving circuit 25, and transmits the demodulated signals to the control circuit 22.

Note that the present embodiment assumes utilizing a reader/writer in the RFID as the receiving apparatus 2. The receiving apparatus 2 may also, however, be an apparatus other than the reader/writer if capable of receiving the information wirelessly transmitted from the wireless communication apparatus 1.

(Information Processing Apparatus 3)

The information processing apparatus 3 is a computer including: a control unit 31 containing a CPU, a RAM (Random Access Memory) and a ROM (Read Only Memory); a storage unit 32 storing a program 5 etc executed by the control unit 31; a communication interface 33 for performing the communications via the network; a drive 34 for reading the program stored on a storage medium 6; and an external interface 35 for establishing a connection with an external device, which are all electrically connected to each other.

As for the specific hardware configuration of the information processing apparatus 3, the components thereof can be properly omitted, replaced and added corresponding to the embodiment. For instance, the control unit 31 may include a plurality of processors. Furthermore, the information processing apparatus 3 may be equipped with output devices such as a display and input devices for inputting such as a mouse and a keyboard. Note that the communication interface and the external interface are abbreviated to the “communication I/F” and the “external I/F” respectively in FIG. 2.

Note that the information processing apparatus 3 is connected to the receiving apparatus 2 via the external I/F 35 so that the information processing apparatus 3 can control the receiving apparatus 2 in the present embodiment. Herein, the information processing apparatus 3 may include a plurality of external I/Fs 35 and may be connected to the external devices through these I/Fs 35. For example, the information processing apparatus 3 may be connected to a control target apparatus of which the operation status is controlled in addition to the receiving apparatus 2 via the external I/F 35. Namely, the information processing apparatus 3 does not control the operation status of the information processing apparatus 3 itself as in the present embodiment but may control the operation status of another apparatus connected to the external I/F 35.

Further, a program 5 is a program for making the information processing apparatus 3 execute steps contained in the operation that will be explained later on, and corresponds to a “program” according to the present invention. Moreover, the program 5 may be recorded on the storage medium 6. The storage medium 6 is a non-transitory medium that accumulates information such as the program electrically, magnetically, optically, mechanically or by chemical action so that the computer, other apparatus and machines, etc can read the information such as the recorded program. The storage medium 6 corresponds to a “non-transitory storage medium” according to the present invention. Note that FIG. 2 illustrates a disk type storage medium such as a CD (Compact Disk) and a DVD (Digital Versatile Disk) by way of one example of the storage medium 6. It does not, however, mean that the type of the storage medium 6 is limited to the disk type, and other types excluding the disk type may be available. The storage medium other than the disk type can be exemplified by a semiconductor memory such as a flash memory.

Note that the information processing apparatus 3 may involve using, in addition to, e.g., an apparatus designed for an exclusive use for a service to be provided, general-purpose apparatuses such as a PC (Personal Computer) and a tablet terminal.

### Example of Functional Configuration

FIG. 3 illustrates a functional configuration of the information processing apparatus 3 according to the present embodiment. The CPU provided in the information processing apparatus 3 according to the present embodiment deploys the program 5 on the RAM, which is stored in the storage unit 32. Then, the CPU interprets and executes the program 5 deployed on the RAM, thereby controlling the respective components. Through this operation, the information processing apparatus 3 according to the present embodiment functions as the computer including a communication status specifying unit 61 and an operation control unit 62. Note that the present embodiment discusses an example in which each of these functions is realized by the general-purpose CPU. Some or the whole of these functions may, however, be realized by one or a plurality of dedicated processors.

The communication status specifying unit 61 determines whether or not the receiving apparatus 2 receives the information transmitted from the wireless communication apparatus 1, thereby specifying the communication status of the wireless communication apparatus 1. Then, the operation control unit 62 controls the operation status of the control target apparatus on the basis of the specified communication status of the wireless communication apparatus 1. Note that the operation control unit 62 controls a start and a stop of a control target function 70 executed by the information processing apparatus 3 in the present embodiment. The control target function 70 is a function of which the start and the stop are controlled by the operation control unit 62. The control target function 70 is not particularly limited but may be properly selected from within the functions equipped in the information processing apparatus 3.

Note that the information transmitted from the wireless communication apparatus 1 may contain identifying information for identifying the user. In this case, the communication status specifying unit 61 may, when determining whether or not the receiving apparatus 2 receives the information transmitted from the wireless communication apparatus 1, specify the communication status of the wireless communication apparatus 1 carried by the predetermined user in a manner that refers to the identifying information contained in the received information. Then, the operation control unit 62 may control the operation status of the control target apparatus on the basis of the specified communication status of the wireless communication apparatus 1 carried by the predetermined user.

Moreover, if the information transmitted from the wireless communication apparatus 1 contains the identifying information, the information processing apparatus 3 according to the present embodiment may function as a computer including at least any one of an operation accepting unit 63 and a history recording unit 64. At this time, the communication status specifying unit 61, when determining whether or not the receiving apparatus 2 receives the information transmitted from the wireless communication apparatus 1, specify the communication status of the wireless communication apparatus 1 carried by the predetermined user in a manner that identifies the user of the wireless communication apparatus 1 by referring to the identifying information contained in the received information.

Then, the operation accepting unit 63 determines whether or not an operation about the information processing apparatus 3 is accepted on the basis of the specified communication status of the wireless communication apparatus 1 carried by the predetermined user. Further, the history recording unit 64 records a history of the specified communication statuses of the wireless communication apparatus 1 carried by the identified user.

Moreover, an area (communicable area) in which the wireless communication apparatus 1 and the receiving apparatus 2 are communicable with each other may be set to include an operation area where the user performs an operation. Then, the operation control unit 62 of the information processing apparatus 3 may keep an operation status of the control target apparatus in a first operation status, corresponding to a situation that the wireless communication apparatus 1 carried by the user is in a communication-enabled status with the receiving apparatus 2 during a period when the user exists in the operation area. Further, the operation control unit 62 of the information processing apparatus 3 may set the operation status of the control target apparatus in a second operation status, corresponding to a situation that the user exits the operation area, and the wireless communication apparatus 1 carried by the user becomes a communication-disabled status with the receiving apparatus 2.

### §3 Operational Example

FIG. 4 illustrates an operational example of the information processing apparatus 3 according to the present embodiment. It is to be noted that a processing procedure of the operational example given in the following discussion is nothing but one example, and the respective processes may be replaced to the greatest possible degree as far as there is no subordination such as using results of processes executed before these former processes. Further, as for the processing procedure of the operational example given in the following discussion, the processes thereof can be properly omitted, replaced and added corresponding to the embodiment.

In step S101, the control unit 31 functions as the communication status specifying unit 61 and determines whether or not the receiving apparatus 2 receives the information transmitted from the wireless communication apparatus 1, thereby specifying the communication status of the wireless communication apparatus 1.

In the present embodiment, the control unit 31 determines whether or not the receiving apparatus 2 connected via the external I/F 35 receives the information transmitted from the wireless communication apparatus 1. Note that the contents of the information transmitted from the wireless communication apparatus 1 may be properly set corresponding to the embodiment.

Steps S102 and S103 relate to processes of the operation control unit 62. Note that the processes (processes in step S101-S103) related to the control of the operation status illustrated in FIG. 4 are periodically repeated in the present embodiment.

This being the case, in step S102, the control unit 31 functions as the operation control unit 62, and determines whether or not a change occurs in the communication status, periodically specified in step S101, of the wireless communication apparatus 1. Then, if the change occurs in the communication status, the control unit 31 advances the processing to next step S103. Whereas if no change occurs in the communication status, the control unit 31 finishes the processes related to the control of the operation status.

Moreover, in step S103, the control unit 31 functions as the operation control unit 62, and changes the operation status of the control target apparatus. In the present embodiment, the control unit 31, when the control target function 70 is already started, stops the control target function 70 kept operating so far. Whereas when the control target function 70 is already stopped, the control unit 31 starts up the control target function 70 kept stopping so far. To be specific, the control unit 31 operates as follows.

(a) Inside of Communicable Area (FIG. 1A)

It is supposed that the user existing outside the communicable area enters the communicable area. In this case, the wireless communication apparatus 1 comes to the communication-enabled status with the receiving apparatus 2 disabled from communications with the wireless communication apparatus 1 during a period when the user exists outside the communicable area. Hence, the communication status specified in step S101 is switched over to the communication-enabled status from the communication-disabled status.

At this time, the control unit 31 determines in step S102 that the change occurs in the communication status. Then, in step S103, the control unit 31 stops the control target function 70 kept operating so far.

Note that the user continues to exist within the communicable area, and the communication status specified in step S101 is maintained in the communication-enabled status, during which the control unit 31 continues to skip the process in step S103 from the process in step S102. Namely, the control unit 31 continues, meanwhile, to keep the stopped status of the control target function 70 without changing the operation status of the control target function 70.

(b) Outside of Communicable Area (FIG. 1B)

While on the other hand, it is supposed that the user existing in the communicable area exits the communicable area and moves away from the communicable area. In this case, the wireless communication apparatus 1 becomes the communication-disabled status with the receiving apparatus 2 enabled to perform the communications with the wireless communication apparatus 1 during a period when the user exists inside the communicable area. Therefore, the communication status specified in step S101 is switched over to the communication-disabled status from the communication-enabled status.

At this time, the control unit 31 determines in step S102 that the change occurs in the communication status. Then, in step S103, the control unit 31 starts up the control target function 70 kept stopping so far.

Note that, similarly to what has been described above, the user continues to exist outside the communicable area, and the communication status specified in step S101 is maintained in the communication-disabled status, during which the control unit 31 continues to keep the started status of the control target function 70 without changing the operation status of the control target function 70.

The operation control system 9 according to the present embodiment controls the operation statuses (which are the start and the stop of the function executed by the information processing apparatus 3 in the present embodiment) of the control target apparatus on the basis of the status of the communications performed between the wireless communication apparatus 1 carried by the user and the receiving apparatus 2. Therefore, the operation control system 9 according to the present embodiment can easily control the operation status of the control target apparatus without being time-consuming in operation of the user.

### §4 Modified Example

The in-depth description of the embodiment of the present invention has been made, however, the description given so far is no more than the exemplification of the present invention in every point. As a matter of course, the invention can be improved and modified in the variety of forms without deviating from the scope of the present invention.

(Restriction of User Operating Power Source)

For example, the information transmitted from the wireless communication apparatus 1 may contain identifying information for identifying the user. In this case, in step S101, the control unit 31 may, when determining whether the receiving apparatus 2 receives the information transmitted from the wireless communication apparatus 1 or not, specify the communication status of the wireless communication apparatus 1 by identifying the user in a manner that refers to the identifying information contained in the received information.

Then, the control unit 31 may, in steps S102 and S103, control the operation status of the control target apparatus on the basis of the communication status of the wireless communication apparatus 1 carried by the predetermined user in a plurality of users. In the case of the present embodiment, the control unit 31 determines in step S102 whether or not the change occurs in the communication status of the wireless communication apparatus 1 carried by the predetermined user. Then, if the change occurs in the communication status, the control unit 31 changes the operation status of the control target function 70 in step S103.

The operation being thus done, the operation status of the control target apparatus can be controlled in the way of identifying the user. Namely, when the plurality of users exists, the users (standing by for) changing the operation statuses of the control target apparatuses can be restricted to the predetermined user. That is, the wireless communication apparatus 1 carried by the specified user in the wireless communication apparatuses carried respectively by the plurality of users can undergo processing related to the control of the operation status.

(Restriction of User Accepting Operation)

Further, for instance, the control unit 31, after specifying the communication status of the wireless communication apparatus 1 by identifying the user in step S101, may function as the operation accepting unit 63. Namely, the control unit 31 may determine, based on the communication status of the wireless communication apparatus 1 carried by the predetermined user in the plurality of users, whether the operation for the information processing apparatus 3 is accepted or not. Note that there is no particular limit to timing when the control unit 31 executes this process. For example, this process may be executed in parallel with steps S102 and S103 and may also be executed before and after step S102 or step S103.

In this case, e.g., the control unit 31 may, when the wireless communication apparatus 1 carried by the predetermined user is in the communication-enabled status, determine not to accept inputs from input devices such as a mouse and a keyboard each connected to the information processing apparatus 3. This contrivance can prevent the predetermined user from operating the information processing apparatus 3. In other words, the operation of the predetermined user about the information processing apparatus 3 can be temporarily locked. At this time, however, the receiving apparatus 2 is disposed to cover, as a communicable area, a range where the predetermined user can exist when operating the information processing apparatus 3.

(Record of History)

Moreover, e.g., the control unit 31, after specifying the communication status of the wireless communication apparatus 1 by identifying the user in step S101, may function as the history recording unit 64. Namely, the control unit 31 may record, on the storage unit 32, a history related to the specified communication status of the wireless communication apparatus 1 carried by the identified user. That is, the control unit 31 may record the history related to the communication status of the wireless communication apparatus 1 on a user-by-user basis. Note that there is no particular limit to timing when the control unit 31 executes this process. For example, this process may be executed in parallel with steps S102 and S103 and may also be executed before and after step S102 or step S103.

In the present embodiment, as depicted in FIGS. 1A and 1B, the assumption is that the wireless communication apparatus 1 carried by the user existing inside the communicable area becomes the communication-enabled status, while the wireless communication apparatus 1 carried by the user existing outside the communicable area becomes the communication-disabled status. For this reason, the information processing apparatus 3 (control unit 31) can determine (presume) from the communication status specified in step S101 whether the user exists inside or outside the communicable area. Therefore, according to the present embodiment, the history related to the communication status of the wireless communication apparatus 1 is recorded on the user-by-user basis. It is therefore feasible to record a history related to the operation control based on the communication status and also a history about whether or not the user exists in the communicable area on the user-by-user basis. In other words, the information processing apparatus 3 can conduct room access control of a predetermined room by adjusting a range of the communicable area so that an interior of the predetermined room becomes the communicable area.

(Concerning Operation Area)

The area (communicable area) in which the wireless communication apparatus 1 with its communication status being specified by the control unit 31 (communication status specifying unit 61) in step S101 can perform the communications with the receiving apparatus 2, may be set to include the operation area where the user carries out the operation. The communicable area can be adjusted by properly setting an intensity of radio waves of the wireless communication apparatus 1 and an installing position of the receiving apparatus 2. Moreover, as described above, a communicable distance between the wireless communication apparatus 1 and the receiving apparatus 2 can be properly adjusted by sealing the metallic material to the wireless communication apparatus 1.

Then, the control unit 31 of the information processing apparatus 3, in step S102, functions as the operation control unit 62 and may keep the operation status of the control target apparatus in the first operation status, corresponding to the situation that the wireless communication apparatus 1 carried by the user is in the communication-enabled status with the receiving apparatus 2 during the period when the user exists in the operation area. Further, the control unit 31 of the information processing apparatus 3, in step S102, functions as the operation control unit 62 and may set the operation status of the control target apparatus in the second operation status, corresponding to the situation that the user exits the operation area, and the wireless communication apparatus 1 carried by the user becomes the communication-disabled status with the receiving apparatus 2.

The first operation status and the second operation status may be properly set corresponding to the embodiment. For example, the status where the control target function 70 is stopped may be selected as the first operation status, while the status where the control target function 70 is started up may be selected as the second operation status. In this case, the control unit 31 keeps the stopped status of the control target function 70 during the period when the user exists in the operation area. Then, the control unit 31 starts up the control target function 70, corresponding to the situation that the user exits the operation area, and the wireless communication apparatus 1 carried by the user becomes the communication-disabled status with the receiving apparatus 2.

Herein, it is assumed that the information processing apparatus 3 having the function, i.e., the control target function 70 serving as the watching system described above is installed in a patient's room of the medical treatment facility or a room of the care facility. In this case, the communicable area may be set so that an interior of the patient's room or an interior of the care facility room becomes the communicable area. With this contrivance, the nurse or the care worker, if carrying the wireless communication apparatus 1 when conducting the operation in the interior of the patient's room or the interior of the care facility room, can control the start and the stop of the function of the watching system without manually operating the information processing apparatus 3.

FIG. 5 illustrates a relationship between the communicable area and the operation area in such a case. By way of one example, the information processing apparatus 3, in order for the watching system not to get into a malfunction when the nurse or the care worker conducts the operation in the interior of the patient's room or the care facility room, may stop the function of the watching system, corresponding to the situation that the wireless communication apparatus 1 and the receiving apparatus 2 are in the communication-enabled status. Then, the information processing apparatus 3, with the nurse or the care worker finishing the operation and exiting the patient's room or the care facility room, may start up the function of the watching system, corresponding to the situation that the wireless communication apparatus 1 and the receiving apparatus 2 become the communication-disabled status.

Note that a range of the communicable area is set so as to be substantially coincident with the operation area in FIG. 5. The operation area is the area where the user conducts the operation but may not be definitely specified. For example, the operation area may be properly determined from the range of the communicable area.

The information processing apparatus 3 operating in this way, the function of the watching system can be started up and stopped without being time-consuming in operation of the nurse or the care worker. It is therefore feasible to prevent the human error such as failing to start up the function. It is to be noted that the stopped status corresponds to the first operation status, while the started status corresponds to the second operation status in this example.

(Concerning Control of Power State)

Further, the information processing apparatus 3 may control a power state of the control target apparatus as the control of the operation status. By way of one example, the power state can be exemplified by a power-on state, a power-off state and a sleep state. The power-on state is a state of the power source when the control target apparatus normally operates. The power-off state is a state of the power source when the control target apparatus stops operating. The sleep state is a state of the power source when the control target apparatus temporarily stops operating and stands by in a power save state. For instance, the information processing apparatus 3 is connected via the external I/F 35 to the control target apparatus in a way that enables the power state to be controlled. Then, the information processing apparatus 3 (control unit 31) may control the power state of the control target apparatus by transitioning the power state of the control target apparatus to any one of the power-on state, the power-off state and the sleep state, corresponding to the change of the communication status between the wireless communication apparatus 1 and the receiving apparatus 2.

### §5 Supplement

Note that the operation control system 9 according to the present embodiment can be utilized in a variety of situations. For instance, the operation control system 9 according to the present embodiment can be utilized for starting up and stopping an application executed on the computer. Further, the operation control system 9 according to the present embodiment can be utilized for starting up and stopping electric products such as lighting equipment and a television.

According to one aspect, the present embodiment aims at providing the technology of easily controlling the operation status of the control target apparatus without being time-consuming in operation of the user. Then, as discussed above, according to the present embodiment, it is feasible to provide the technology of easily controlling the operation status of the control target apparatus without being time-consuming in operation of the user.

1. An operation control system comprising:
a wireless communication apparatus to be carried by a user;
a receiving apparatus to receive information transmitted from the wireless communication apparatus; and
an information processing apparatus to control a control target apparatus, to specify a communication status of the wireless communication apparatus by determining whether or not the receiving apparatus receives the information transmitted from the wireless communication apparatus, and to control an operation status of the control target apparatus on the basis of the specified communication status.

2. The operation control system according to claim 1, wherein the information processing apparatus, by way of controlling the operation status, controls starting up and stopping a function executed on the information processing apparatus.

3. The operation control system according to claim 1, wherein the information transmitted from the wireless communication apparatus contains identifying information for identifying the user, and
the information processing apparatus specifies the communication status of the wireless communication apparatus carried by a predetermined user in a way that refers to the identifying information contained in the received information when determining whether or not the receiving apparatus receives the information transmitted from the wireless communication apparatus, and controls the operation status of the control target apparatus on the basis of the specified communication status of the wireless communication apparatus carried by the predetermined user.

4. The operation control system according to claim 1, wherein the information transmitted from the wireless communication apparatus contains identifying information for identifying the user, and
the information processing apparatus specifies the communication status of the wireless communication apparatus carried by a predetermined user in a way that refers to the identifying information contained in the received information when determining whether or not the receiving apparatus receives the information transmitted from the wireless communication apparatus, and determines whether or not an operation with respect to the information processing apparatus is accepted on the basis of the specified communication status of the wireless communication apparatus carried by the predetermined user.

5. The operation control system according to claim 1, wherein the information transmitted from the wireless communication apparatus contains identifying information for identifying the user, and
the information processing apparatus identifies the user of the wireless communication apparatus in a way that refers to the identifying information contained in the received information when determining whether or not the receiving apparatus receives the information transmitted from the wireless communication apparatus, and records a history related to the specified communication status of the wireless communication apparatus carried by the identified user.

6. The operation control system according to claim 1, wherein a communicable area between the wireless communication apparatus and the receiving apparatus is set to include an operation area in which the user conducts an operation, and
the information processing apparatus keeps the operation status of the control target apparatus in a first operation status, corresponding to a situation that the wireless communication apparatus carried by the user is in a communication-enabled status with the receiving apparatus during a period when the user exists in the operation area, and sets the operation status of the control target apparatus in a second operation status, corresponding to a situation that the user exits the operation area, and the wireless communication apparatus carried by the user becomes a communication-disabled status with the receiving apparatus.

7. An information processing method by which a computer executes:
specifying a communication status of a wireless communication apparatus by determining whether or not a receiving apparatus receives information transmitted from the wireless communication apparatus carried by a user; and
controlling an operation status of a control target apparatus on the basis of the specified communication status of the wireless communication apparatus.

8. A non-transitory recording medium recording a program to make a computer execute:
specifying a communication status of a wireless communication apparatus by determining whether or not a receiving apparatus receives information transmitted from the wireless communication apparatus carried by a user; and
controlling an operation status of a control target apparatus on the basis of the specified communication status of the wireless communication apparatus.
